(19) United States
(12) Patent Application Publication
(10) Pub. No.: US 2024/0301130 A2
(43) Pub. Date: Sep. 12, 2024

(54) STORAGE STABLE EPOXY RESIN COMPOSITION (II)

(71) Applicant: Alzchem Trostberg GmbH, Trostberg (DE)

(72) Inventors: Dominik ZGELA, Truchtlaching (DE); Peter DIJKINK, Garching (DE); Florian RITZINGER, Garching (DE)

(73) Assignee: Alzchem Trostberg GmbH, Trostberg (DE)

(21) Appl. No.: 18/269,676

(22) PCT Filed: Jan. 20, 2022
(86) PCT No.: PCT/EP2022/051177

§ 371 Date: Jun. 26, 2023

(30) Foreign Application Priority Data
Jan. 26, 2021 (DE) 10 2021 101 685.1

(51) Int. Cl. C08G 59/40; C08J 5/24; C08K 5/55; C09J 163/00

(52) U.S. Cl. CPC C08G 59/4021; C08J 5/243; C08K 5/55; C09J 163/00; C08J 2363/00

(57) ABSTRACT

The present invention relates to the use of boronic acids to increase the storage stability of epoxy resin compositions and epoxy resin compositions comprising an epoxy resin and a curing agent and a boronic acid.

### CROSS REFERENCE TO RELATED APPLICATIONS

This application is a U.S. national phase of International Patent Application No. PCT/EP2022/051177 filed on Jan. 20, 2022, which claims priority to German Patent Application No. 10 2021 101 685.1, filed on Jan. 26, 2021. The contents of all applications are hereby incorporated herein by this reference in their entirety for all intents and purposes.

### DESCRIPTION

The present invention relates to the use of boronic acids to increase the storage stability of epoxy resin compositions and epoxy resin compositions comprising an epoxy resin and a curing agent and a boronic acid.

The use of epoxy resins is widespread due to their good chemical resistance, their very good thermal and dynamic-mechanical properties and their high electrical insulation capacity. These epoxy resins are available in liquid or solid form and can be cured with or without the addition of curing agents under application of heat.

The curing of epoxy resins proceeds according to different mechanisms. In addition to curing with phenols or anhydrides, curing with amines is often carried out. These substances are usually liquid and can be mixed very well with epoxy resins. Due to the high reactivity, such epoxy resin compositions are performed using two components. This means that resin (A-component) and curing agent (B-component) are stored separately and are mixed in the correct ratio only shortly before use. These two-component resin formulations are also referred to as so-called cold-curing resin formulations, whereby the curing agents used for this are usually selected from the group of amines or amidoamines.

Single-component, hot-curing epoxy resin formulations, on the other hand, are ready-to-use and pre-assembled, i.e. epoxy resin and curing agent are mixed at the factory. Mixing errors of the individual components during local use are therefore excluded. The prerequisite for this are latent curing systems, which do not react with the epoxy resin at room temperature, but react readily when heated, depending on the application of energy. In this context, “latent” means that a mixture of the individual components is stable under defined storage conditions.

For such single-component epoxy resin formulations, dicyandiamide, for example, is a particularly suitable and also cost-effective curing agent. Under ambient conditions, corresponding epoxy resin-dicyandiamide mixtures can be stored ready for use for up to twelve (12) months.

In order to lower the reaction temperature for curing single-component epoxy resin formulations, such as epoxy resin-dicyandiamide mixtures, a curing accelerator is commonly added to these formulations which lowers the activation energy for curing so that curing at lower temperatures is possible. However, these curing accelerators in many cases reduce the storage stability of epoxy resin compositions comprising an epoxy resin, a curing agent, and a curing accelerator, such that storage at room temperature for a significant period of time is not possible. Nevertheless, to ensure adequate storage stability of these single-component epoxy resin formulations, they must be stored at controlled, low temperatures, often at −18° C. Similar storage conditions must be maintained when less latent hardeners are used in epoxy resins.

This results in considerable additional costs and effort for storage, transportation and processing of this formulation, in particular for the production of prepregs, towpregs or adhesives.

Knowing such barriers, suggestions to overcome these have already been published. For example, the European patent specification EP 659793 B1 describes mixtures of boric acid or borates (boric acid esters) and imidazole-epoxy resin adducts as curing agents for epoxy resins. The compositions thus obtained are stable in storage and allow rapid curing by heating.

Furthermore, the European patent specification EP 2678369 B1 describes liquid curing agents which contain cyanamide, at least one urea derivative (urone) and at least one organic or inorganic acid as stabilizer. These curing agents dissolve excellently in epoxy resins, exhibit a high latency in the epoxy resins and allow a long storage stability.

In addition, it is known from European patent specification EP 2780388 B1 that N,N′-dimethylurones can cure epoxy resins as sole curing agents without the addition of a curing accelerator.

Furthermore, the European patent application EP 3257884 A1 describes an epoxy resin mixture of epoxy resin, dicyandiamide, aromatic urone and boric acid ester.

The effectiveness of the boric acid esters listed in the examples, in particular the extension of the time to peak in the heat flow curve at 60° C., is so low that it is doubtful whether the addition of these esters can eliminate the need for frozen storage and frozen transport.

In addition, German patent application DE 10 2019 121 195.6 describes an epoxy resin composition comprising a curing agent, a curing accelerator and a boronic acid for stabilizing the epoxy resin composition.

The present invention is therefore directed to providing an epoxy resin composition comprising a curing agent, which can be stored for a substantial period of time of several days without curing being observed. This epoxy resin composition should have a high latency and thus a high storage stability below the curing temperature, as well as a high reactivity at the curing temperature.

These tasks could be solved by a use according to claim 1 as well as an epoxy resin composition according to claim 6. Preferred embodiments of the invention are given in the subclaims, which may optionally be combined with each other.

Thus, according to a first embodiment, the use of boronic acids of the general formula (I) for increasing the storage stability of epoxy resin compositions, in particular liquid epoxy resin compositions, comprising an epoxy resin, in particular a liquid epoxy resin and a curing agent for curing the epoxy resin is subject matter of the present invention, wherein formula (I) represents

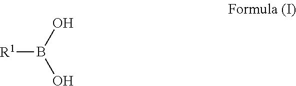

wherein radical R¹ means:
R¹=alkyl, hydroxyalkyl or a radical of formula (II), wherein formula (II) is

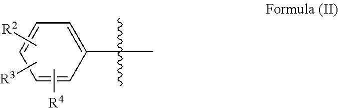

wherein R², R³, R⁴ independently of one another mean and at least one radical R², R³, R⁴ is not hydrogen:
R², R³, R⁴=hydrogen, fluorine, chlorine, bromine, iodine, cyano, C₁ to C₅ alkyl, alkoxy, acyl, alkylsulfonyl, aryl, carboxyl, or B(OH)₂,
wherein the epoxy resin composition comprises, as a curing agent, a curing agent according to formula (III), wherein formula (III) is:

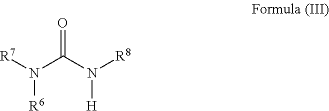

wherein R⁶, R⁷, R⁸ independently of one another mean:
R⁶, R⁷=independently of one another hydrogen or C₁ to C₅ alkyl,
R⁸=C₁ to C₁₅ alkyl substituted with —NHC(O)NR⁶R⁷,
   C₃ to C₁₅ cycloalkyl substituted with —NHC(O)NR⁶R⁷,
   aryl substituted with —NHC(O)NR⁶R⁷ or
   alkylaryl substituted with —NHC(O)NR⁶R⁷,
and wherein the epoxy resin composition does not comprise, in addition to the curing agent according to general formula (III), a curing agent selected from the group consisting of cyanamide, guanidines, cyanoguanidines, nitroguanidines, acylguanidines, biguanidines and a curing agent according to general formula (IV), wherein formula (IV) is as follows

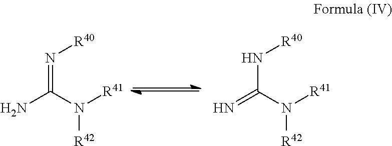

wherein radicals R⁴⁰, R⁴¹, R⁴² independently of one another mean:
R⁴⁰=cyano, nitro, acyl or a radical of the formula —(C═X)—R⁴³, with
X=imino or oxygen,
R⁴³=amino, alkylamino or alkoxy,
R⁴¹=hydrogen, C₁ to C₅ alkyl, aryl, benzyl, or acyl,
R⁴²=hydrogen or C₁ to C₅ alkyl.

Particularly preferably, the epoxy resin composition does not comprise any further curing agents, co-curing agents, curing accelerators or other catalysts for curing epoxy resins at all in addition to the curing agent of the general formula (III).

Thus, according to a further embodiment, the use of boronic acids of the general formula (I) for increasing the storage stability of epoxy resin compositions, in particular liquid epoxy resin compositions, comprising an epoxy resin, in particular a liquid epoxy resin and a curing agent for curing the epoxy resin is subject matter of the present invention, wherein formula (I) represents

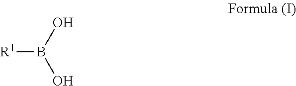

wherein radical R¹ means:
R¹=alkyl, hydroxyalkyl or a radical of formula (II), wherein formula (II) is

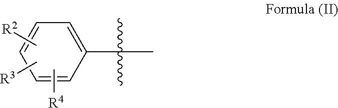

wherein R², R³, R⁴ independently of one another mean and at least one radical R²,
R³, R⁴ is not hydrogen:
R², R³, R⁴=hydrogen, fluorine, chlorine, bromine, iodine, cyano, C₁ to C₅ alkyl, alkoxy, acyl, alkylsulfonyl, aryl, carboxyl, or B(OH)₂,
wherein the epoxy resin composition comprises, as a curing agent, a curing agent according to formula (III), wherein formula (III) is:

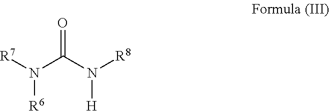

wherein R⁶, R⁷, R⁸ independently of one another mean:
R⁶, R⁷=independently of one another hydrogen or C₁ to C₅ alkyl,
R⁸=C₁ to C₁₅ alkyl substituted with —NHC(O)NR⁶R⁷,
   C₃ to C₁₅ cycloalkyl substituted with —NHC(O)NR⁶R⁷,
   aryl substituted with —NHC(O)NR⁶R⁷ or
   alkylaryl substituted with —NHC(O)NR⁶R⁷,
and wherein the epoxy resin composition does not comprise any further curing agents, co-curing agents, curing accelerators or other catalysts for curing epoxy resins in addition to the curing agent of the general formula (III).

Surprisingly, it has been shown that an addition of boronic acids according to formula (I) of the invention to epoxy resin compositions containing an epoxy resin, a curing agent according to formula (III) significantly improves the storage stability of the epoxy resin composition thus already prepared for curing. For example, the latency of a TDI-urone-containing epoxy resin composition can be increased by a factor of 6 to 12 by adding boronic acids according to the invention (cf. examples), so that corresponding epoxy resin compositions can be stored at room temperature up to 40° C. for a period of at least 2 months longer and thus kept in stock without curing compared to an otherwise identical composition, but without the addition of boronic acids according to the invention. Completely surprisingly, it has been shown that the desired storage stability is achieved without significantly changing the reactivity of the composition. The addition of boronic acids does not affect the glass transition temperature to be achieved or the mechanical properties of fiber-reinforced composites. Thus, the curing properties of the curing agents and curing accelerators as a whole, which are achieved without the addition of the boronic acids, are not changed and are essentially maintained. These facts are surprising in their entirety. Overall, therefore, an epoxy resin composition can be provided which exhibits high storage stability at room temperature and high reactivity at the curing temperature, and which is eminently suitable for use in prepregs, towpregs and 1-component adhesives, as well as acoustic insulation materials.

According to the present invention, epoxy resin composition means a composition which epoxy resins are thermosetting, i.e. are polymerizable, linkable and/or cross-linkable by heat due to their functional groups, namely epoxy groups. Here, polymerization, linkage and/or crosslinking occurs as a result of a polyaddition induced by the curing agent.

In the context of the present invention, alkyl is to be understood as a saturated, linear or branched aliphatic radical, in particular an alkyl radical having the general formula CₙH₂ₙ₊₁, where n represents the number of carbon atoms of the radical. Alkyl may mean a radical having a greater number of carbon atoms. Preferably, alkyl means a saturated, linear or branched aliphatic radical having the general formula CₙH₂ₙ₊₁, where n represents the number of carbon atoms of the radical and n represents a number from 1 to 15. Thus alkyl preferably means C₁ to C₁₅ alkyl, more preferably C₁ to C₁₀ alkyl. Thereby, it is further preferred that C₁ to C₁₅ alkyl is in particular methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, n-heptyl, n-octyl, n-nonyl, n-decyl, n-undecyl, n-dodecyl, n-tridecyl, n-tetradecyl or n-pentadecyl.

Furthermore, C₁ to C₅ alkyl means a saturated, linear or branched alkyl radical having up to five carbon atoms. Preferably, C₁ to C₅ alkyl means in particular methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-methylbutyl, 1,1-dimethylpropyl, 1,2-dimethylpropyl, 2,2-dimethylpropyl or 1-ethylpropyl.

According to the present invention, hydroxyalkyl means an alkyl radical as defined above substituted with one, two or three hydroxy groups. In particular, according to the present invention, hydroxyalkyl means an alkyl radical which has up to 15 carbon atoms and which is substituted with a hydroxy group. Thus, hydroxyalkyl preferably means C₁ to C₁₅ hydroxyalkyl. Further preferably, hydroxyalkyl means C₁₋ to C₅ hydroxyalkyl. Most preferably, hydroxyalkyl means hydroxymethyl, 2-hydroxyethyl, 3-hydroxypropyl, 4-hydroxybutyl or 5-hydroxypentyl.

In the context of the present invention, it is further intended that C₃ to C₁₅ cycloalkyl means a saturated, monocyclic or bicyclic aliphatic radical having 3 to carbon atoms, in particular a cycloalkyl radical having the general formula CₙH₂ₙ₋₁, where n=an integer from 3 to 15. In this context, it is preferably intended that C₃ to C₁₅ cycloalkyl means in particular cyclopropyl, cyclobutyl, cyclopentyl, cyclohexyl or cycloheptyl, wherein these cycloalkyl radicals in turn may further be preferably mono- or polysubstituted by alkyl of the meaning described above.

According to the present invention, C₃ to C₁₅ cycloalkyl particularly preferably means cyclopentyl, cyclohexyl, which in turn may be mono- or polysubstituted with alkyl, in particular 3,3,5,5-tetramethyl-1-cyclohexyl.

Cyano denotes a nitrile group of the general formula CN.

Nitro denotes a functional group of the general formula NO₂.

Amino denotes a functional group of the general formula NH₂.

Imino denotes a functional group of the general formula NH.

Alkylamino means a radical of the formula NHₙ (alkyl)₂₋ₙ, with n=0 or 1, wherein alkyl is an alkyl radical of the meaning given above and wherein the binding site is located on the nitrogen.

Carboxyl denotes a functional group of the general formula COOH.

Alkoxy means a radical of the formula O-alkyl, wherein alkyl is an alkyl radical of the meaning given above and wherein the binding site is located on the oxygen. According to the present invention, alkoxy means, in particular, an alkoxy radical which alkyl radical has up to 15 carbon atoms, in particular up to 5 carbon atoms. Thus, alkoxy preferably means C₁ to C₁₅ alkoxy and more preferably C₁ to C₅ alkoxy. Particularly preferably, alkoxy means methoxy, ethoxy, n-propoxy-, n-butoxy or n-pentoxy.

Acyl means a radical of the formula C(O)—R⁵, wherein R⁵ is bonded to the carbon and hydrogen, alkyl or alkoxy may be of the meaning given above, and wherein the binding site of the acyl radical is located on the carbon. Particularly preferably, acyl means formyl or acetyl.

Further, alkylsulfonyl means a radical of the formula SO₂-alkyl, wherein both the binding site of the alkylsulfonyl radical and the alkyl radical are located on the sulfur and wherein alkyl is an alkyl radical of the meaning given above. According to the present invention, alkylsulfonyl in particular means an alkylsulfonyl radical which alkyl radical has up to 15 carbon atoms. Thus, alkylsulfonyl preferably means C₁ to C₁₅ alkylsulfonyl and more preferably C₁ to C₅ alkylsulfonyl. Particularly preferably, alkylsulfonyl means methylsulfonyl, ethylsulfonyl, n-propylsulfonyl, n-butylsulfonyl or n-pentylsulfonyl.

According to the present invention, aryl means an aromatic radical, in particular an aromatic radical having 6 to 15 carbon atoms, which may be monocyclic, bicyclic or polycyclic. Thus, aryl preferably means C₆ to C₁₅ aryl, in particular benzylphenyl or a C₆ to C₁₅ aryl radical which in turn is monosubstituted with arylalkyl, in particular arylmethyl, in particular phenylmethyl. Particularly preferably, aryl means phenyl, naphthyl, anthryl, phenantryl, pyrenyl or perylenyl, most preferably phenyl.

Furthermore, according to the present invention, alkylaryl means an aromatic radical of the type described above, which is in turn mono- or polysubstituted with alkyl of the type described above. In particular, alkylaryl means an aromatic radical having 6 to 15 carbon atoms. Thus, alkylaryl preferably means C₆ to C₁₅ alkylaryl. Further preferably, alkylaryl means methylphenyl, dimethylphenyl or trimethylphenyl.

According to the invention, boronic acids of formula (I) can be employed or used, wherein R¹ in formula (I) may mean alkyl, hydroxyalkyl or a radical of formula (II). Preferably, R¹ in formula (I) can be alkyl or hydroxyalkyl, wherein it is further preferably provided that R¹ has the following meaning:
R¹=methyl, ethyl, n-propyl, 1-methylethyl, n-butyl, 1-methylpropyl, 2-metylpropyl, n-pentyl, n-hexyl, n-heptyl, n-octyl, n-nonyl, n-decanyl, hydroxymethyl, 2-hydroxyethyl, 3-hydroxypropyl, 4-hydroxybutyl or 5-hydroxypentyl.

According to the present invention, R¹ can also be a radical of formula (II), wherein at least one substituent R², R³, R⁴ is not hydrogen. Thus, alternatively, R¹ in formula (I) can preferably mean a radical of formula (II), wherein radicals R², R³, R⁴ in formula (II) mean:
R²=fluorine, chlorine, bromine, iodine, cyano, C₁ to C₅ alkyl, alkoxy, acyl, alkylsulfonyl, aryl, carboxyl or B(OH)₂,
R³, R⁴=hydrogen.

Further preferably, R¹ in formula (I) can be a radical of formula (II), wherein radicals R², R³, R⁴ in formula (II) mean:
R²=fluorine, acyl, alkoxy or B(OH)₂,
R³, R⁴=hydrogen.

Even more preferably, R¹ in formula (I) can be a radical of formula (II), wherein radicals R², R³, R⁴ in formula (II) mean:
R²=fluorine, formyl, acetyl, methoxy, ethoxy, n-propoxy, -n-butoxy, n-pentoxy, or B(OH)₂,
R³, R⁴=hydrogen.

According to a further alternative, boronic acids according to formula (I) can preferably also be employed or used, wherein R¹ in formula (I) preferably means a radical of the formula (II), wherein radicals R², R³, R⁴ in formula (II) mean:
R², R³=independently of one another fluorine, chlorine, bromine, iodine, cyano, C₁ to C₅ alkyl, alkoxy, acyl, alkylsulfonyl, aryl, carboxyl or B(OH)₂,
R⁴=hydrogen.

Further preferably, R¹ in formula (I) can be a radical of formula (II), wherein radicals R², R³, R⁴ in formula (II) mean:
R², R³=independently of one another fluorine, acyl, alkoxy or B(OH)₂,
R⁴=hydrogen.

Even more preferably, R¹ in formula (I) can be a radical of formula (II), wherein radicals R², R³, R⁴ in formula (II) mean:
R², R³=independently of one another fluorine, formyl, acetyl, methoxy, ethoxy, n-propoxy, n-butoxy, n-pentoxy -or B(OH)₂,
R⁴=hydrogen.

According to a further alternative, boronic acids according to formula (I) can preferably be used or employed, wherein R¹ in formula (I) preferably means a radical of formula (II), wherein radicals R², R³, R⁴ in formula (II) independently of one another mean:
R², R³, R⁴=fluorine, chlorine, bromine, iodine, cyano, C₁ to C₅ alkyl, alkoxy, acyl, alkylsulfonyl, aryl, carboxyl or B(OH)₂.

Further preferably, R¹ in formula (I) can be a radical of formula (II), wherein radicals R², R³, R⁴ in formula (II) independently of one another mean:
R², R³, R⁴=fluorine or C₁ to C₅ alkyl.

Even more preferably, R¹ in formula (I) can be a radical of formula (II), wherein radicals R², R³, R⁴ in formula (II) independently of one another mean:
R², R 3, R 4=fluorine, methyl, ethyl, n-propyl, 1-methylethyl, n-butyl, 1-methylpropyl, 2-methylpropyl, 1,1-dimethylethyl, n-pentyl.

Very preferably, formula (I) represents a substance selected from the group consisting of 4-formylphenylboronic acid, 1,4-benzenediboronic acid, 3-fluorophenylboronic acid, 2,4-difluorophenylboronic acid, 2,5-dimethoxyphenylboronic acid, methylboronic acid, 4-ethylphenylboronic acid, 1-octylboronic acid, 2-carboxy-phenylboronic acid, 3-carboxyphenylboronic acid, 4-carboxyphenylboronic acid, (2-hydroxymethyl)phenylboronic acid, 4-cyanophenylboronic acid, 4-(methanesulfonyl)phenylboronic acid, 3,4,5-trifluorophenylboronic acid or mixtures thereof.

The use of these boronic acids in epoxy resin compositions can improve the storage stability of epoxy resin compositions already prepared for curing to an exceptionally high degree.

Very preferably, compounds of the formula (III) are used as curing agents in which all radicals R⁶ and R⁷ are identical, in particular methyl, ethyl, n-propyl, i-propyl, n-butyl or n-pentyl. Preferably, at least the two radicals R⁶ and the two radicals R⁷ are identical, the radicals being selected from the group consisting of methyl, ethyl, n-propyl, i-propyl, n-butyl and n-pentyl. However, the two radicals R⁶ or the two radicals R⁷ or all four radicals may also be different from one another, in which cases the radicals are also preferably selected from the group consisting of methyl, ethyl, n-propyl, i-propyl, n-butyl or n-pentyl.

According to a further idea, therefore, an epoxy resin composition, in particular a liquid epoxy resin composition, is also subject matter of the present invention, which comprises an epoxy resin, in particular a liquid epoxy resin, and a curing agent for curing the epoxy resin, as well as at least one boronic acid of the general formula (I), wherein formula (I) represents:

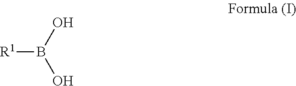

wherein radical R¹ means:
R¹=alkyl, hydroxyalkyl or a radical of the formula (II), wherein formula (II) is

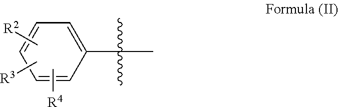

wherein R², R³, R⁴ independently of one another mean and at least one radical R², R³, R⁴ is not hydrogen:
R², R³, R⁴=hydrogen, fluorine, chlorine, bromine, iodine, cyano, C₁ to C₅ alkyl, alkoxy, acyl, alkylsulfonyl, aryl, carboxyl, or B(OH)₂,
wherein the epoxy resin composition comprises, as curing agent, a curing agent according to formula (III), wherein formula (III) is:

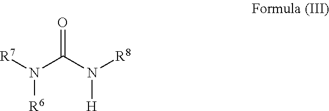

wherein R⁶, R⁷, R⁸ independently of one another mean:
R⁶, R⁷=independently of one another hydrogen or C₁ to C₅ alkyl,
R⁸=C₁ to C₁₅ alkyl substituted with —NHC(O)NR⁶R⁷, C₃ to C₁₅ cycloalkyl substituted with —NHC(O)NR⁶R⁷, aryl substituted with —NHC(O)NR⁶R⁷ or alkylaryl substituted with —NHC(O)NR⁶R⁷,
and wherein the epoxy resin composition does not comprise, in addition to the curing agent according to general formula (III), a curing agent selected from the group consisting of cyanamide, guanidines, cyanoguanidines, nitroguanidines, acylguanidines, biguanidines and a curing agent according to general formula (IV), wherein formula (IV) is as follows

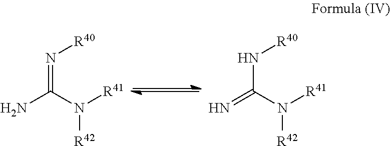

wherein radicals R⁴⁰, R⁴¹, R⁴² independently of one another mean:
R⁴⁰=cyano, nitro, acyl or a radical of the formula —(C═X)—R⁴³, with
   X=Imino or oxygen,
   R⁴³=amino, alkylamino or alkoxy,
R⁴¹=hydrogen, C₁ to C₅ alkyl, aryl, benzyl, or acyl,
R⁴²=hydrogen or C₁ to C₅ alkyl.

Particularly preferably, also in this embodiment, the epoxy resin composition does not comprise any further curing agents, co-curing agents, curing accelerators or other catalysts for curing epoxy resins at all in addition to the curing agent of the general formula (III).

Thus, an epoxy resin composition, in particular a liquid epoxy resin composition, comprising an epoxy resin, in particular a liquid epoxy resin, and a curing agent for curing the epoxy resin is also subject matter of the present invention, wherein formula (I) represents

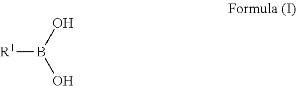

wherein radical R¹ means:
R¹=alkyl, hydroxyalkyl or a radical of the formula (II), wherein formula (II) is

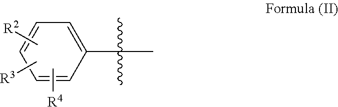

wherein R², R³, R⁴ independently of one another mean and at least one radical R²,
R³, R⁴ is not hydrogen:
R², R³, R⁴=hydrogen, fluorine, chlorine, bromine, iodine, cyano, C₁ to C₅ alkyl, alkoxy, acyl, alkylsulfonyl, aryl, carboxyl, or B(OH)₂,
wherein the epoxy resin composition comprises as curing agent a curing agent according to formula (III), wherein formula (III) is:

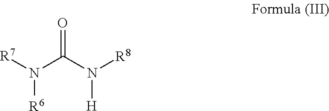

wherein R⁶, R⁷, R⁸ independently of one another mean:
R⁶, R⁷=independently of one another hydrogen or C₁ to C₅ alkyl,
R⁸=C₁ to C₁₅ alkyl substituted with —NHC(O)NR⁶R⁷,
   C₃ to C₁₅ cycloalkyl substituted with —NHC(O)NR⁶R⁷,
   aryl substituted with —NHC(O)NR⁶R⁷ or
   alkylaryl substituted with —NHC(O)NR⁶R⁷,
and wherein the epoxy resin composition does not comprise any further curing agents, co-curing agents, curing accelerators or other catalysts for curing epoxy resins in addition to the curing agent of the general formula (III).

According to a further idea, it is thus also an object of the present invention to provide an epoxy resin composition, in particular a liquid epoxy resin composition, consisting of at least one epoxy resin, in particular at least one liquid epoxy resin, and a curing agent for curing the epoxy resin and at least one boronic acid of the general formula (I), the curing agent consisting of at least one urea derivative according to formula (III).

Surprisingly, it has been shown that such epoxy resin compositions are particularly stable in storage. Thus, it has been shown that epoxy resin compositions according to the invention have significantly higher storage stabilities (cf. Examples) compared to known epoxy resin compositions. The epoxy resin compositions according to the invention can be stored at least 6 to 16 times longer, i.e. by at least a factor of 6 to 16, than the comparable epoxy resin compositions without boronic acids under the same conditions, or have longer storage stability. Quite surprisingly, it has been shown that the other curing properties, such as the reactivity of the composition, are comparable to curing properties of known compositions and are not significantly changed. Thus, these compositions can be excellently used for the production of prepregs, towpregs and 1-component adhesives as well as acoustic insulation materials.

Preferred embodiments of the above use, in particular the use of preferred boronic acids are also preferred embodiments of the inventive epoxy resin compositions. Thus, the inventive epoxy resin compositions preferably comprise boronic acids according to formula (I), wherein R¹ in formula (I) can preferably mean alkyl or hydroxyalkyl. Further preferably, R¹ hin formula (I) can mean:
R¹=methyl, ethyl, n-propyl, 1-methylethyl, n-butyl, 1-methylpropyl, 2-methylpropyl, n-pentyl, n-hexyl, n-heptyl, n-octyl, n-nonyl, n-decanyl, hydroxymethyl, 2-hydroxyethyl, 3-hydroxypropyl, 4-hydroxybutyl or 5-hydroxypentyl.

According to the present invention, R¹ may also be a radical of formula (II), wherein at least one substituent R², R³, R⁴ is not hydrogen. Thus, the epoxy resin composition may alternatively preferably comprise a boronic acid according to formula (I), in which R¹ is a radical of formula (II), wherein radicals R², R³, R⁴ in formula (II) mean:
R²=fluorine, chlorine, bromine, iodine, cyano, C₁ to C₅ alkyl, alkoxy, acyl, alkylsulfonyl, aryl, carboxyl or B(OH)₂,
R³, R⁴=hydrogen.

Further preferably, R¹ in formula (I) may be a radical of formula (II), wherein R², R³, R⁴ in formula (II) mean:
R²=fluorine, acyl, alkoxy or B(OH)₂,
R³, R⁴=hydrogen.

Even more preferably, R¹ in formula (I) may be a radical of formula (II), wherein R², R³, R⁴ in formula (II) mean:
R²=fluorine, formyl, acetyl, methoxy, ethoxy, n-propoxy, -n-butoxy, n-pentoxy or B(OH)₂,
R³, R⁴=hydrogen.

According to a further alternative, the epoxy resin composition may alternatively preferably also comprise a boronic acid according to formula (I), in which R¹ is a radical of formula (II), wherein radicals R², R³, R⁴ in formula (II) mean:
R², R³=independently of one another fluorine, chlorine, bromine, iodine, cyano, C₁ to C₅ alkyl, alkoxy, acyl, alkylsulfonyl, aryl, carboxyl or B(OH)₂,
R⁴=hydrogen.

Further preferably, R¹ in formula (I) may be a radical of formula (II), wherein R², R³, R⁴ in formula (II) mean:
R², R³=independently of one another fluorine, acyl, alkoxy or B(OH)₂,
R⁴=hydrogen.

Even more preferably, R¹ in formula (I) may be a radical of formula (II), wherein R², R³, R⁴ in formula (II) mean:
R², R³=independently of one another fluorine, formyl, acetyl, methoxy, ethoxy, n-propoxy, n-butoxy, n-pentoxy or B(OH)₂,
R⁴=hydrogen.

According to a further alternative, the epoxy resin composition may alternatively preferably also comprise a boronic acid according to formula (I), in which R¹ is a radical of formula (II), wherein radicals R², R³, R⁴ in formula (II) independently of one another mean:
R², R³, R⁴=fluorine, chlorine, bromine, iodine, cyano, C₁ to C₅ alkyl, alkoxy, acyl, alkylsulfonyl, aryl, carboxyl or B(OH)₂.

Further preferably, R¹ in formula (I) may be a radical of formula (II), wherein R², R³, R⁴ in formula (II) independently of one another mean:
R², R³, R⁴=fluorine or C₁ to C alkyl.

Even more preferably, R¹ in formula (I) may be a radical of formula (II), wherein R², R³, R⁴ in formula (II) independently of one another mean:
R², R³, R⁴=fluorine, methyl, ethyl, n-propyl, 1-methylethyl, n-butyl, 1-methylpropyl, 2-methylpropyl, 1,1-dimethylethyl, n-pentyl.

Most preferably, the epoxy resin composition may comprise a boronic acid selected from the group consisting of 4-formylphenylboronic acid, 1,4-benzenediboronic acid, 3-fluorophenylboronic acid, 2,4-difluorophenylboronic acid, 2,5-dimethoxyphenylboronic acid, methylboronic acid, 4-ethylphenylboronic acid, 1-octylboronic acid, 2-carboxyphenylboronic acid, 3-carboxyphenylboronic acid, 4-carboxyphenylboronic acid, (2-hydroxymethyl)phenylboronic acid, 4-cyanophenylboronic acid, 4 (methanesulfonyl)phenylboronic acid, 3,4,5-trifluorophenylboronic acid or mixtures thereof.

According to the present invention, urea derivatives according to formula (III) are used or employed as curing agents for curing the epoxy resin, wherein formula (III) represents

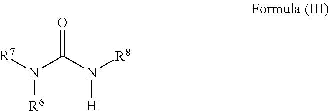

wherein R⁶, R⁷, R⁸ independently of one another mean:
R⁶, R⁷=independently of one another hydrogen or C₁ to C₅ alkyl,
R⁸=C₁ to C₁₅ alkyl substituted with —NHC(O)NR⁶R⁷,
   C₃ to C₁₅ cycloalkyl substituted with —NHC(O)NR⁶R⁷,
   aryl substituted with —NHC(O)NR⁶R⁷ or
   alkylaryl substituted with —NHC(O)NR⁶R⁷.

Due to their properties, these urea derivatives can be used particularly well for the gentle curing of epoxy resins and epoxy resin compositions.

Of the urea derivatives described by formula (III), aromatic urea derivatives can preferably be employed or used in accordance with the present invention. Further preferred are aromatic urea derivatives of formula (III), wherein radicals R⁶, R⁷, R⁸ independently mean:
R⁶, R⁷=independently of one another C₁ to C₅ alkyl, in particular methyl or ethyl,
R⁸=aryl substituted with —NHC(O)NR⁶R⁷ or alkylaryl substituted with —NHC(O)NR⁶R⁷.

Further preferably, radicals R⁶, R⁷, R⁸ may independently of one another be:
R⁶, R⁷=independently of one another C₁ to C₅ alkyl, in particular methyl or ethyl,
R⁸=alkylaryl substituted with —NHC(O)NR⁶R⁷.

Thus, according to the present invention, urea derivatives according to formula (III) are particularly preferred, in which a urea derivative according to formula (V) represents a urea derivative according to formula (III). According to the present invention, urea derivatives according to formula (V) are particularly preferred, wherein formula (V) is:

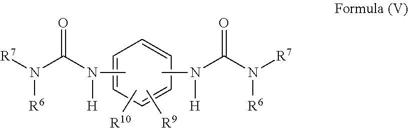

and wherein radicals R⁶, R⁷, R⁹, R¹⁰ independently of one another mean:
R⁶, R⁷=independently of one another hydrogen or C₁ to C₅ alkyl, in particular methyl or ethyl,
R⁹, R¹⁰=independently of one another hydrogen or C₁ to C₅ alkyl, in particular hydrogen, methyl or ethyl.

Preferably, radicals R⁶, R⁷, R⁹ in connection with formula (V) each mean a methyl radical and R¹⁰ means hydrogen. Particularly preferred is 1,1′-(4-methyl-m-phenylene)bis(3,3-dimethylurea) and 1,1′-(2-methyl-m-phenylene)bis(3,3-dimethylurea).

Further preferably, radicals R⁶, R⁷, R⁸ may independent of one another be:
R⁶, R⁷=independently of one another C₁ to C₅ alkyl, in particular methyl or ethyl,
R⁸=aryl substituted with —NHC(O)NR⁶R⁷, in particular benzylphenyl substituted with —NHC(O)NR⁶R⁷.

Thus, according to the present invention, urea derivatives according to formula (III) are particularly preferred, in which a urea derivative according to formula (VII) represents a urea derivative according to formula (III). In accordance with the present invention, urea derivatives according to formula (VII) are particularly preferred, wherein formula (VII) is

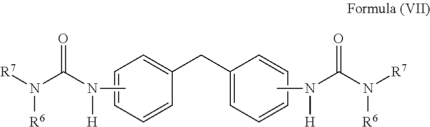

and wherein radicals R⁶, R⁷ independently of one another mean:
R⁶, R⁷=independently of one another hydrogen or C₁ to C₅ alkyl, in particular methyl or ethyl.

Particularly preferably, radicals R⁶, R⁷ in connection with formula (VII) each mean methyl. Very particularly preferred is 1,1′-(methylenedi-p-phenylene)bis[3,3-dimethylurea].

Of the urea derivatives described by formula (III), aliphatic urea derivatives can also preferably be used. Aliphatic urea derivatives of the formula (III) are further preferred, wherein radicals R⁶, R⁷, R⁸ independently mean:
R⁶, R⁷=independently of one another hydrogen or C₁ to C₅ alkyl, in particular methyl or ethyl,
R⁸=C₁ to C₁₅ alkyl substituted with —NHC(O)NR⁵R⁶ or C₃ to C₁₅ cycloalkyl substituted with —NHC(O)NR⁵R⁶.

Further preferred are aliphatic urea derivatives according to formula (III) in which R⁶ and R⁷ are as defined above, in particular methyl or ethyl, and R³ is C₁ to C₁₅ cycloalkyl substituted with —NHC(O)NR¹R².

Thus, according to the present invention, urea derivatives according to formula (III) are particularly preferred, in which a urea derivative according to formula (VI) represents a urea derivative according to formula (III). According to the present invention, urea derivatives according to formula (VI) are particularly preferred, wherein formula (VI) is:

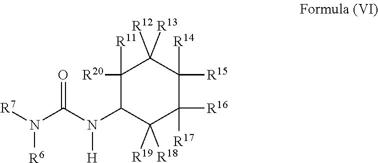

wherein the radicals simultaneously or independently of each other mean:
R⁶, R⁷=independently of one another hydrogen or C₁ to C₅ alkyl, in particular methyl or ethyl;
R¹¹, R¹², R¹³, R¹⁴, R¹⁵, R¹⁶, R¹⁷, R¹⁸, R¹⁹, R²⁰=independently of one another hydrogen, C₁ to C₅ alkyl or C₁ to C₅ alkyl substituted with —NHC(O)NR⁶R⁷,
wherein one of the radicals R¹¹, R¹², R¹³, R¹⁴, R¹⁵, R¹⁶, R¹⁷, R¹⁸, R¹⁹ or R²⁰ is C₁ to C₅ alkyl substituted with —NHC(O)NR⁶R⁷.

Further preferred are curing agents comprising aliphatic urea derivatives of the formula (VI) in which R⁶ and R⁷ independently of one another are methyl or ethyl and R¹¹, R¹², R¹³, R¹⁴, R¹⁵, R¹⁶, R¹⁷, R¹⁸, R¹⁹, R²⁰ independently of one another are hydrogen, methyl, ethyl, —NHC(O)NR⁶R⁷ or methyl or ethyl substituted with —NHC(O)NR⁶R⁷. Particularly preferred is 1-(N,N-dimethylurea)-3-(N,N-dimethylurea-methyl)-3,5,5-trimethylcyclohexane, hereinafter also N′-[3-[[[(dimethylamino)carbonyl]amino]methyl]-3,5,5-trimethylcyclohexyl]-N,N-dimethylurea (i.e., R⁶=R⁷=R¹²=R¹³=R¹⁶ methyl and R¹⁷=—CH₂—NHC(O)N(CH₃)₂ and R¹¹=R¹⁴=R¹⁵=R¹⁸=R¹⁹=R²⁰=hydrogen).

Thus, an epoxy resin composition is also preferred, in particular a liquid epoxy resin composition comprising an epoxy resin, in particular a liquid epoxy resin, and a curing agent for curing the epoxy resin selected from the group of curing agents according to formula (V) or formula (VI) or formula (VII), and at least one boronic acid of the general formula (I), where formula (I) represents:

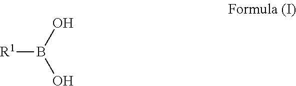

wherein radical R¹ means:
R¹=alkyl, hydroxyalkyl or a radical of the formula (II), where formula (II) is

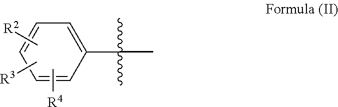

wherein R², R³, R⁴ independently of one another mean and at least one radical R², R³, R⁴ is not hydrogen:
R², R³, R⁴=hydrogen, fluorine, chlorine, bromine, iodine, cyano, C₁ to C₅ alkyl, alkoxy, acyl, alkylsulfonyl, aryl, carboxyl, or B(OH)₂,
wherein formula (V) represents:

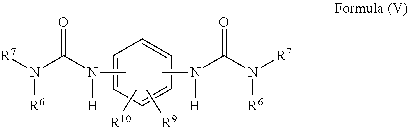

and wherein radicals R⁶, R⁷, R⁹, R¹⁰ independently of one another mean:
R⁶, R⁷=independently of one another hydrogen or C₁ to C₅ alkyl, in particular methyl or ethyl,
R⁹, R¹⁰=independently of one another hydrogen or C₁ to C₅ alkyl, in particular hydrogen, methyl or ethyl,
wherein formula (VI) is

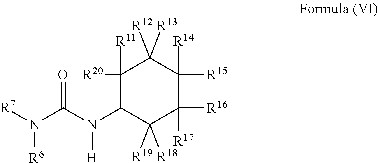

wherein the radicals simultaneously or independently of each other mean:
R⁶, R⁷=independently of one another hydrogen or C₁ to C₅ alkyl, in particular methyl or ethyl;
R¹¹, R¹², R¹³, R¹⁴, R¹⁵, R¹⁶, R¹⁷, R¹⁸, R¹⁹, R²⁰=independently of one another hydrogen, C₁ to C₅ alkyl, in particular methyl or ethyl, or C₁ to C₅ alkyl substituted with —NHC(O)NR⁶R⁷, in particular methyl or ethyl substituted with —NHC(O)NR⁶R⁷
wherein one of the radicals R¹¹, R¹², R¹³, R¹⁴, R¹⁵, R¹⁶, R¹⁷, R¹⁸, R¹⁹ or R²⁰ is C₁ to C₅ alkyl substituted with —NHC(O)NR⁶R⁷,
wherein formula (VII) is

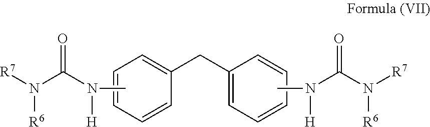

and wherein radicals R⁶, R⁷ independently of one another mean:
R⁶, R⁷=independently of one another hydrogen or C₁ to C₅ alkyl, in particular methyl or ethyl,
wherein the epoxy resin composition does not comprise, in addition to the curing agent of general formula (V) or formula (VI) or formula (VII), a curing agent selected from the group consisting of cyanamide, guanidines, cyanoguanidines, nitroguanidines, acylguanidines, biguanidines, and a curing agent according to general formula (IV), wherein formula (IV) is:

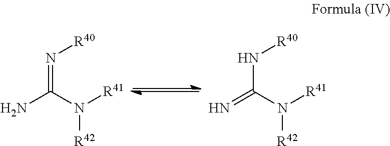

wherein radicals R⁴⁰, R⁴¹, R⁴² independently of one another mean:
R⁴⁰=cyano, nitro, acyl or a radical of the formula —(C═X)—R⁴³, with
   X=imino or oxygen,
   R⁴³=amino, alkylamino or alkoxy,
R⁴¹=hydrogen, C₁ to C alkyl, aryl, benzyl, or acyl,
R⁴²=hydrogen or C₁ to C₅ alkyl.

Particularly preferably, also in this embodiment, the epoxy resin composition does not comprise any further curing agents, co-curing agents, curing accelerators or other catalysts for curing epoxy resins at all in addition to the curing agent of the general formula (V) or formula (VI) or formula (VII).

Thus, an epoxy resin composition is also preferred, in particular a liquid epoxy resin composition comprising an epoxy resin, in particular a liquid epoxy resin, and a curing agent for curing the epoxy resin selected from the group of curing agents according to formula (V) or formula (VI) or formula (VII), and at least one boronic acid of the general formula (I), where formula (I) represents:

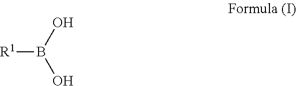

wherein radical R¹ means:
R¹=alkyl, hydroxyalkyl or a radical of the formula (II), wherein formula (II) is

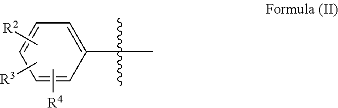

wherein R², R³, R⁴ independently of one another mean and at least one radical R², R³, R⁴ is not hydrogen:
R², R³, R⁴=hydrogen, fluorine, chlorine, bromine, iodine, cyano, C₁ to C₅ alkyl, alkoxy, acyl, alkylsulfonyl, aryl, carboxyl, or B(OH)₂,
wherein formula (V) is:

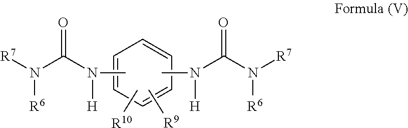

and wherein radicals R⁶, R⁷, R⁹, R¹⁰ independently of one another mean:
R⁶, R⁷=independently of one another hydrogen or C₁ to C₅ alkyl, in particular methyl or ethyl,
R⁹, R¹⁰=independently of one another hydrogen or C₁ to C₅ alkyl, in particular hydrogen, methyl or ethyl,
wherein formula (VI) is

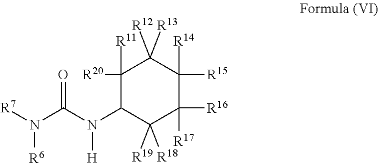

wherein the radicals simultaneously or independently of each other mean:
R⁶, R⁷=independently of one another hydrogen or C₁ to C₅ alkyl, in particular methyl or ethyl;
R¹¹, R¹², R¹³, R¹⁴, R¹⁵, R¹⁶, R¹⁷, R¹⁸, R¹⁹, R²⁰=independently of one another hydrogen, C₁ to C₅ alkyl, in particular methyl or ethyl, or C₁ to C₅ alkyl substituted with —NHC(O)NR⁶R⁷, in particular methyl or ethyl substituted with —NHC(O)NR⁶R⁷
wherein one of the radicals R¹¹, R¹², R¹³, R¹⁴, R¹⁵, R¹⁶, R¹⁷, R¹⁸, R¹⁹ or R²⁰ is C₁ to C₅ alkyl substituted with —NHC(O)NR⁶R⁷,
wherein formula (VII) is

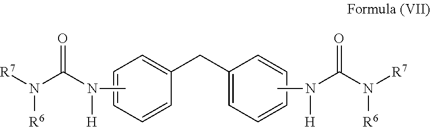

and wherein radicals R⁶, R⁷ independently of one another mean:
R⁶, R⁷=independently of one another hydrogen or C₁ to C₅ alkyl, in particular methyl or ethyl,
and wherein the epoxy resin composition does not comprise any curing agents, co-curing agents, curing accelerators or other catalysts for curing epoxy resins other than the curing agent of the general formula (V), or formula (VI) or formula (VII).

According to a further idea, it is thus also subject matter of the present invention to provide an epoxy resin composition, in particular a liquid epoxy resin composition, consisting of at least one epoxy resin, in particular at least one liquid epoxy resin, and a curing agent for curing the epoxy resin and at least one boronic acid of the general formula (I), the curing agent consisting of at least one urea derivative according to formula (V) or formula (VI) or formula (VII).

According to the invention, the epoxy resin composition comprises at least one epoxy resin, in particular a liquid epoxy resin. Preferably, the epoxy resin or liquid epoxy resin is a polyether having at least one, preferably at least two epoxy groups and even more preferably at least three epoxy resin groups. These epoxy resins or liquid epoxy resins may have at least one, preferably at least two epoxy groups and may be saturated or unsaturated, aliphatic, cycloaliphatic, aromatic or heterocyclic. Furthermore, these epoxy resins or liquid epoxy resins, may have substituents such as halogens, phosphorus and hydroxyl groups. Bisphenol-based epoxy resins, in particular bisphenol A diglycidyl ether as well as the bromine-substituted derivative (tetrabromobisphenol A) or bisphenol F diglycidyl ether, novolak epoxy resins, in particular epoxyphenol novolak or aliphatic epoxy resins are preferably used in this context. Epoxy resins based on glycidyl polyethers of 2,2-bis-(4-hydroxyphenyl)propane (bisphenol A) and the bromine-substituted derivative (tetrabromobisphenol A), glycidyl polyethers of 2,2-bis-(4-hydroxyphenyl)methane (bisphenol F) and glycidyl polyethers of novolaks as well as those based on aniline or substituted anilines such as p-aminophenol or 4,4′-diaminodiphenylmethanes are particularly preferred. Epoxy resins based on glycidyl polyethers of 2,2-bis(4-hydroxyphenyl)-propane (bisphenol A) and epoxy resins based on glycidyl polyethers of 2,2-bis(4-hydroxyphenyl)methane (bisphenol F) are particularly preferred.

Further preferably, according to the present invention, such epoxy resins, in particular liquid epoxy resins, can be used having an EEW (epoxide equivalent weight) value in the range of EEW=100 to 1500 g/eq, in particular in the range of EEW=100 to 1000 g/eq, in particular in the range of EEW=100 to 600 g/eq, further preferably in the range of EEW=100 to 400 g/eq and very particularly preferably in the range of EEW=100 to 300 g/eq.

The curing profile of the inventive formulations can be varied by adding further, commercially available additives, such as known to the skilled person for curing epoxy resins.

Reactive diluents and thermoplastic additives are commonly used in prepreg, towpreg and adhesive formulations. Thus, in addition to the epoxy resin, the curing agent and the boronic acid, the epoxy resin composition according to the invention may also comprise a reactive diluent and/or a thermoplastic additive.

In particular, glycidyl ethers can be used as reactive diluents in the method according to the invention or in the epoxy resin matrix. In this context, monofunctional, di- and polyfunctional glycidyl ethers can be preferably used. In particular, glycidyl ethers, diglycidyl ethers, triglycidyl ethers, polyglycidyl ethers and multiglycidyl ethers and combinations thereof are to be mentioned. Particularly preferred, glycidyl ethers selected from the group comprising 1,4-butanediol diglycidyl ether, trimethylolpropane triglycidyl ether, 1,6-hexanediol diglycidyl ether, cyclohexanedimethanol diglycidyl ether, C₈-C₁₀ alcohol glycidyl ether, C₁₂-C₁₄ alcohol glycidyl ether, cresol glycidyl ether, poly(tetramethylene oxide) diglycidyl ether, 2-ethylhexyl glycidyl ether, polyoxypropylene glycol diglycidyl ether, polyoxypropylene glycol triglycidyl ether, neopentyl glycol diglycidyl ether, p-tert-butylphenol glycidyl ether, polyglycerol multiglycidyl ether, and combinations thereof may be used.

Very particularly preferred glycidyl ethers are 1,4-butanediol diglycidyl ether, trimethylolpropane triglycidyl ether, neopentyl glycol diglycidyl ether, 1,6-hexanediol diglycidyl ether, cyclohexanedimethanol diglycidyl ether, and combinations thereof.

Typically, thermoplastic additives from the groups of phenoxy resins, acrylate, acryl, acrylonitrile, polyetherimide, polyetherketone or polysulfone polymers are selected. Due to their positive influence on the flow behaviour during processing and the mechanical properties of the cured component, phenoxy resins, polyacrylates or polysulphones are preferably used.

Additives for improving the processability of the uncured epoxy resin compositions or for adapting the thermo-mechanical properties of the thermoset products to the requirement profile include, for example, fillers, rheological additives such as thixotropic agents or dispersing additives, defoamers, dyes, pigments, toughness modifiers, impact modifiers, nanofillers, nanofibers, or fire protection additives.

The amounts of boronic acids to be used according to the invention, as well as the curing agents in the epoxy resin compositions, can be adjusted according to the present invention with respect to the amount of epoxy resins to be used. Preferably, based on 100 parts by weight of epoxy resin, in particular 0.05 to 3.0 parts by weight of boronic acid according to formula (I), further preferably 0.1 to 2.0 parts by weight of boronic acid according to formula (I) and particularly preferably 0.1 to 1.0 parts by weight of boronic acid according to formula (I) can be used.

Furthermore, based on 100 parts by weight of epoxy resin, in particular 1 to 15 parts by weight of curing agent, in particular from the group of curing agents according to formula (III) or formula (V) or formula (VI) or formula (VII), can be used. Further preferably, according to the present invention, at least 2 parts by weight of curing agent, further preferably at least 3, further preferably at least 4, even further preferably at least 5 and very particularly preferably at least 6 parts by weight of curing agent can be used, in each case based on 100 parts by weight of epoxy resin, and, independently thereof, further preferably at most 14 parts by weight of curing agent, further preferably at most 13 parts by weight, further preferably at most 12 parts by weight, even further preferably at most 11 parts by weight and very particularly preferably at most 10 parts by weight of curing agent, in each case based on 100 parts by weight of epoxy resin.

Thus, an epoxy resin composition according to the invention comprises preferably, based on 100 parts by weight of epoxy resin, in particular 4 to 12 parts by weight of curing agent, and very particularly preferably 6 to 10 parts by weight of curing agent, in particular from the group of curing agents according to formula (III) or formula (V) or formula (VI) or formula (VII).

In this regard, the epoxy resin composition may preferably comprise the curing agent and the boronic acid in a weight ratio of curing agent to boronic acid corresponding to a ratio in the range from 1:1 to 300:1, more preferably from 2:1 to 120:1, and particularly preferably from 6:1 to 100:1.

As mentioned above, the epoxy resin compositions described herein can be stored for a relatively long period of time without curing being observed. In addition, these epoxy resin compositions exhibit a curing profile that permits a wide range of applications. However, epoxy resins according to the invention are particularly suitable for use in fiber composites.

Thus, the use of an epoxy resin composition of the type described herein for the manufacture of a fiber composite, prepregs and towpregs is also within the scope of the present invention.

Fiber composites such as prepregs or towpregs are characterized by the fact that they are pre-impregnated and partially cured fiber composites consisting of an epoxy resin and fibers. These partially cured materials are in a so-called B-stage, a partially cured state. Since in this state the corresponding epoxy resin composition is only partially cured, progressive curing of the epoxy resin can continue to occur. In the case of epoxy resin formulations based on epoxy resin-urone mixtures, corresponding fiber composites such as prepregs and towpregs may continue to react at room temperature, thus negatively affecting the desired properties and quality of the fiber composites. Thus, storage at room temperature for a longer period of time is not possible. To ensure adequate storage stability of fiber composites such as prepregs or towpregs, they must be stored at controlled, low temperatures, often at −18° C. This results in considerable additional costs and great effort during storage, transport and processing of prepregs and towpregs. Therefore, it is advantageous if the epoxy resin composition used guarantees a high latency to extend the storage conditions of fiber composites such as prepregs and towpregs in favor of their properties and quality. Epoxy resin compositions according to the invention exhibit high latency to a particular degree. Thus, epoxy resin compositions according to the invention of the type described herein are particularly suitable for solving this problem.

Likewise, the fiber composite material itself is also subject matter of the present invention, which comprises:
a) a carrier material, in particular reinforcing fibers, and
b) an epoxy resin composition according to the invention.

Fiber composites, in particular prepregs and towpregs, are used for the production of fiber composite components in very different industrial sectors. For example, fiber composites are used in the automotive industry to manufacture interior trim or fenders, or in the aerospace industry for a wide variety of components. In addition, fiber composites are used to manufacture sports and free-time equipment, such as tennis rackets or bicycle frames, as well as rotor blades for wind turbines. All types of fibers known to the skilled person can be used for these fiber composites. For example, glass, carbon, aramid, plastic, basalt, and natural fibers, or rock wool are used. These fiber composites can be processed in autoclaves, out-of-autoclave, vacuum bags and pressing methods.

With regard to the selection of the carrier materials to be used, reinforcing fibers in particular, and further preferably reinforcing fibers selected from the group consisting of carbon fibers, glass fibers, aramid fibers and basalt fibers, can thus be used in accordance with the present invention.

These reinforcing fibers may further preferably be provided or used in the form of filaments, threads, yarns, woven, braided or knitted fabrics.

Furthermore, reinforcing fibers can also be selected from silicon carbide, aluminum oxide, graphite, tungsten carbide, boron. Furthermore, reinforcing fibers can also be selected from the group of natural fibers such as seed fibers (e.g. kapok, cotton), bast fibers (e.g. bamboo, hemp, kenaf, flax) or leaf fibers (such as henequen, abac). Likewise, combinations of these reinforcing fibers can also be used as carrier material.

As mentioned above, the epoxy resin compositions described herein can be stored for a relatively long period of time without curing being observed. In addition, these epoxy resin compositions have a curing profile that exhibits a wide range of applications. Epoxy resins according to the invention are therefore also particularly suitable for use in 1K adhesives (1-component adhesives) and acoustic insulating materials. These adhesives and insulating materials are used, for example, in automotive and aircraft construction.

Thus, the use of an epoxy resin composition of the type described herein for the production of a 1K adhesive or an acoustic insulating material is also subject matter of the present invention.

A large number of adhesives or acoustic insulation materials based on 1K epoxy resin compositions are available for use in a liquid, medium-viscosity to high-viscosity state. On an industrial scale, these must be brought to an appropriate processing temperature before use. Since barrels are preferably used for fully continuous mass production, the adhesive or acoustic insulating material contained therein must be processed by means of barrel heating mats, or often by means of a melting plate of a barrel melting system. The use of a melting plate, which is attached to the stamp of the barrel melting system, places the epoxy resin composition under particular thermal stress. Since the stamp has to be pressed against the epoxy resin to transport the melted epoxy resin-based adhesive or acoustic insulation material, the pressure of the stamp on the barrel contents generates additional shear forces that further heat the epoxy resin locally to a high degree. The molten resin must thus be conveyed through a small hose connection attached to the stamp, which usually leads to an application head or assembly gun or melter. This pressure- and temperature-intensive stress has a negative influence on the pot life and leads to a reduction in the latency of the epoxy resin composition. As a result, the property of the adhesive or acoustic insulation material can be degraded. Therefore, it is advantageous if the epoxy resin composition used for adhesives and acoustic insulating materials guarantees a high latency in order to guarantee a high latency extension during stress, but also during storage, of the material in favor of the adhesive and insulating properties and thus the quality. Thus, epoxy resin compositions according to the invention of the type described herein are particularly suitable for solving this problem.

### EXAMPLES

### Materials Used

Product name: EPIKOTE™ Resin 828 (Hexion Inc.)
Unmodified bisphenol A epoxy resin (EEW=184-190 g/eq)
(viscosity at 25° C.=12-14 Pa*s)
Urea 1: 1,1′-(4-methyl-m-phenylene)-bis-(3,3-dimethylurea) (AlzChem Trostberg GmbH)
bifunctional curing agent according to formula V, solid material (particle size 98%≤μm)
Urea 2: 1,1′-(methylenedi-p-phenylene)bis[3,3-dimethylurea] (AlzChem Trostberg GmbH)
bifunctional curing agent according to formula VII, solid material
Urea 3: N′-[3-[[[(dimethylamino)carbonyl]amino]methyl]-3,5,5-trimethylcyclohexyl]-N,N-dimethyl urea (AlzChem Trostberg GmbH)
bifunctional curing agent according to formula VI, solid material
Product name: 3-fluorophenylboronic acid; (abcr GmbH)
Solid material, (melting point=220° C.)
Product name: 2,5-dimethoxyphenylboronic acid; (Alfa Aesar)
Solid material (purity=98%; melting point=92-94° C.)
Product name: 1-octylboronic acid; (Alfa Aesar)
Solid material (purity=97%; melting point=81-85° C.)
Product name: 1,4-benzenediboronic acid (Alfa Aesar)
Solid material (purity=96%; melting point>300° C.)
Product Name: Toray T700 16500d 24k
Unidirectional carbon fiber (basis weight 314 g/m²)

### Preparation of the Mixtures

For the investigations of the formulations mentioned in the examples, the individual components of the respective formulation are mixed in a mortar for several minutes until homogeneity is achieved. The formulations listed in Table 1 have been converted to 10 g epoxy resin for this purpose.

Production of Fiber Composites and their Test Pieces

To produce the fiber composites, six layers of Toray T700 16500d 24k carbon fiber are cut to 15 cm by 13 cm. In a mortar, the individual components of each formulation are mixed at 40° C. for several minutes until homogeneity is achieved. The formulations listed in Table 2 have been converted to 100 g epoxy resin for this purpose. The carbon fibers are stacked unidirectionally and hand-laminated with the formulation.

The curing of the impregnated fibers is carried out between two aluminum plates for 2 h at 120° C. The formulations Ref.4 and K were cured for 2 h at 120° C. and 1 h at 130° C., respectively. After curing, the fiber composites are demolded from the aluminum plates. Subsequently, the corresponding test pieces for the measurement of the glass transition temperature by means of dynamic mechanical thermal analysis (DMTA-Tg), based on EN ISO 11357-1 and ASTM D 4065, the mechanical measurement of the interlaminar shear strength (ILSS), based on EN ISO 14130, and the mechanical measurement of the bending properties by means of a 3-point bending test, based on EN ISO 14125, are cut out of the fiber composites:

TABLE A
Test pieces dimensions of the fiber composites
for corresponding measurements

| | Length of test | Width of test | Height of test |
|---|---|---|---|
| Test method | piece [mm] | piece [mm] | piece [mm] |
| 3-point bending test | 100 | 15 | 2.4 |
| DMTA-Tg | 40 | 10 | 2.4 |
| ILSS | 20 | 10 | 2.4 |

### Methods Used to Characterize the Compositions

### DSC Investigations

DSC measurements are performed on a dynamic heat flow difference calorimeter DSC 1 or DSC 3 (Mettler Toledo).
a) Tg determination:
For the determination of the maximum glass transition temperature (final Tg), a sample of the cured formulation is subjected to the following DSC temperature program: heating from 30-200° C. at 20 K/min, 10 min holding at 200° C., cooling from 200-50° C. at 20 K/min, 5 min holding at 50° C., heating from 50-200° C. at 20 K/min, 10 min holding at 200° C., cooling from 200-50° C. at 20 K/min, 5 min holding at 50° C., heating from 50-220° C. at 20 K/min. The glass transition temperature is determined from the last two heating cycles in each case by applying a tangent at the inflection point of the largest change in heat capacity (ΔCp) and the average value is given as the final TG.
b) Isothermal DSC:
A sample of the formulation is kept constantly at the specified temperature for the specified time (isothermal curing of the formulation). The evaluation is performed by determining the time of the 90% conversion (as a measure for the end of the curing process) of the exothermic reaction peak.
c) Latency:
To determine the latency (storage stability), approx. 10 g of the respective formulation are freshly prepared and then stored at a temperature of 40° C. in a heating cabinet. By regularly measuring the dynamic viscosity, the progressive cross-linking (hardening) of the formulation under these storage conditions is recorded. The dynamic viscosity is determined using a Haake viscometer [cone (1°)-plate method, measurement at 25° C., shear rate 5.0 s⁻¹]. A formulation is classified as storage stable (still suitable for processing) until the viscosity doubles.

### Mechanical-Investigations

Measurements of the interlaminar shear strength (ILSS) and bending properties (3-point bending test) of the fiber composites are performed on a Zwick Z010 materials testing machine. The testXpertII software is used to evaluate the measurement results.
a) ILSS (EN ISO 14130):
The test pieces of the fiber composites are measured at a test speed of 1 mm/min. The radius of the compression fin is 5 mm, the radius of the supports is 2 mm. The support width (distance between the two supports) is L=10 mm.
b) 3-point bending test (EN ISO 14125):
The test pieces of the fiber composites are measured at a test speed of 1 mm/min. The radius of the compression fin is 5 mm, the radius of the supports is 2 mm. The support width (distance between the two supports) is L=80 mm.

Dynamic Mechanical Thermal Analysis

DMTA measurements are performed using Anton Paar's Modular Compact Rheometer MCR 302 with Convection Heating System CTD 450, and analyses are performed using Anton Paar's RHEOPLUS/32 software.
a) DMTA-Tg (EN ISO 11357-1 and ASTM D 4065):
For the determination of the glass transition temperature in the fiber composite, the sample is subjected to an oscillating deformation of 0.01% at a frequency of 1 Hz for 30 minutes. The sample is heated from 50-200° C. at 5 K/min. The normal force is −0.5 N. The midpoint Tg of the sample is given as the glass transition temperature.

### Carbon Fiber Content

The carbon fiber content of the fiber composite is given in mass fractions. The mass of the carbon fiber and the mass of the fiber composites made from it are determined and the quotient is formed from this.

### Listing of the Results

TABLE 1a
Latency of epoxy resin compositions in comparison

| Formulations | Ref. 1 | A | B | C | D |
|---|---|---|---|---|---|
| EPIKOTE ™ Resin 828 | 100 | 100 | 100 | 100 | 100 |
| Urea 1 | 8.0 | 8.0 | 8.0 | 8.0 | 8.0 |
| 1-octylboronic acid | | 0.4 | | | |
| 1,4-benzendiboronic acid | | | 0.4 | | |
| 3-fluorophenylboronic acid | | | | 0.4 | |
| 2,5-dimethoxyphenylboronic acid | | | | | 0.4 |
| Dynamic DSC | | | | | |
| Final Tg [° C.] | 98 | 96 | 100 | 98 | 98 |
| Isothermal DSC; 1 h at 140° C. | | | | | |
| Time to 90% conversion [min] | 25 | 26 | 26 | 27 | 24 |
| Latency at 40° C. [days] | 3 | 18 | 37 | 28 | 26 |

TABLE 1b
Latency of epoxy resin compositions in comparison

| Formulations | Ref. 2 | E | F | G | H |
|---|---|---|---|---|---|
| EPIKOTE ™ Resin 828 | 100 | 100 | 100 | 100 | 100 |
| Urea 2 | 8.0 | 8.0 | 8.0 | 8.0 | 8.0 |
| 1-octylboronic acid | | 0.4 | | | |
| 1,4-benzendiboronic acid | | | 0.4 | | |
| 3-fluorophenylboronic acid | | | | 0.4 | |
| 2,5-dimethoxyphenylboronic | | | | | 0.4 |
| acid | | | | | |
| Dynamic DSC | | | | | |
| Final Tg [° C.] | 101 | 99 | 102 | 101 | 102 |
| Isothermal DSC; 1 h at 140° C. | | | | | |
| Time to 90% conversion [min] | 40 | 40 | 42 | 42 | 43 |
| Latency at 40° C. [days] | 8 | 67 | >96 ^{a)} | 95 | 93 |

^{a)} After 96 days, a 1.6-fold increase in viscosity is achieved for formulation F.

Description and Evaluation of the Results from Table 1a and Table 1b

Comparison of Examples A to D according to the invention with Ref. 1 and Examples E to H according to the invention with Ref. 2, each consisting of a urone-based curing agent in a commercially available epoxy resin, shows that comparable characteristic values for the curing process can be determined when using the boronic acids according to the invention. This can be determined from the values obtained from DSC analysis, including by determining the final Tg and recording an isothermal DSC at 140° C. to determine the 90% conversion of the cure. The latency measurement confirms that by adding the boronic acids of the invention, of Examples A to D and E to H, the latency at 40° C. can be extended. For Examples A to D compared to Ref. 1, there is an increase in latency by a factor of 6 to 12. For Examples E to H compared to Ref. 2, there is an increase in latency by a factor of 8 to 12 or beyond a factor of 12. Thus, the result from the latency measurement of example F shows that the doubling of viscosity has not yet been achieved in the applied measurement period. For example F, the result is a 1.6-fold increase in viscosity when the measurement is stopped after 96 days. Since Ref. 2 achieves a 1.6-fold increase in viscosity after 6 days, this results in an increase in latency for formulation F by a factor of 16.

Thus, the comparison of formulation Ref. 1 and formulations A to D as well as the comparison of formulation Ref. 2 and formulations E to H shows that by means of the boronic acids according to the invention, epoxy resin-based prepregs, towpregs as well as adhesives can achieve an extended latency of more than 18 weeks at 40° C., with unchanged curing properties. For the skilled person, manufacturer and user of prepregs, towpregs and adhesives and acoustic insulation materials, this means easier handling of these products so that they can be stored, transported and processed without refrigeration. For products according to the correspondingly mentioned formulations A to H, based on the boronic acids according to the invention, this results in over 16 times longer shelf life and storability, especially for prepregs, towpregs and adhesives. This can lead to fewer rejects, less waste and thus reduced costs. This reduces the consumption of expensive raw materials such as carbon fiber and protects the environment.

TABLE 2
Mechanical and dynamic mechanical properties
of fiber composites in comparison

| Formulations | Ref. 3 | I | Ref. 4 | K |
|---|---|---|---|---|
| EPIKOTE ™ Resin 828 | 100 | 100 | 100 | 100 |
| Urea 1 | 8.0 | 8.0 | 8.0 | 8.0 |
| Urea 3 | | | | |
| 1,4-benzendiboronic acid | | 0.4 | | 0.2 |
| 1-octylboronic acid | | | | |
| Carbon fiber content [%] | 56 | 56 | 56 | 55 |
| DMTA-Tg | | | | |
| Tg Midpoint [° C.] | 117 | 120 | 118 | 118 |
| Interlaminar shear strength | | | | |
| ILSS [MPa] | 63 | 65 | 59 | 60 |
| Bending properties | | | | |
| Bending modulus [GPa] | 77 | 75 | 72 | 76 |
| Bending strength [MPa] | 972 | 940 | 844 | 876 |
| Breaking elongation [%] | 1.2 | 1.2 | 1.1 | 1.1 |

Description and Evaluation of the Results from Table 2

The comparison of Examples I according to the invention with Ref.3 and K with Ref.4 shows that there is no influence on the dynamic mechanical and mechanical properties of the fiber composites by using the epoxy resin composition according to the invention. The determined Tg midpoint of Examples I according to the invention compared to Ref.3 and K compared to Ref.4 is in each case in a constant, identical value range. An influence of the epoxy resin composition according to the invention cannot be detected here. Typical value ranges can be determined in the mechanical properties of the unidirectional, hand-laminated fiber composites. The bending modulus and the bending strengths of the respective test pieces also confirm the absence of property changes due to the epoxy resin composition according to the invention. The values for breaking elongation are in the same range of values in each case. The interlaminar shear strength, which reflects the same loading capacity when the layers of the fiber composite are sheared off, show no significant changes in the fiber composite. Therefore, no significant influence of the epoxy resin composition according to the invention can be observed in the mechanical properties either.

Thus, the comparison of formulation Ref. 3 and I as well as the comparison of formulation Ref. 4 and K shows that the boronic acids according to the invention in fiber composites of epoxy resin-based prepregs and towpregs have no changes in the final properties for fiber composite components. Furthermore, extended latency beyond 18 weeks at 40° C. also remains for fiber composites such as prepregs and towpregs, so that the skilled person, manufacturer and user of prepregs and towpregs obtains a consistent fiber composite quality. In addition, the production of the fiber composites shows that even when using the boronic acid according to the invention, the manufacturing process of the fiber composite does not have to be changed or redesigned, since the final properties for components made from it do not change.

1. A method for increasing storage stability of epoxy resin compositions, the method comprising:
providing an epoxy resin composition comprising an epoxy resin and a curing agent for curing the epoxy resin; and
adding boronic acids of the general formula (I) to the epoxy resin composition, wherein formula (I) represents: 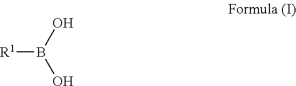
wherein radical R¹ represents an
alkyl, hydroxyalkyl or a radical of formula (II), wherein formula (II) is: 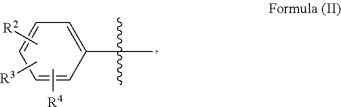
wherein R², R³, and R⁴ are independently one of hydrogen, fluorine, chlorine, bromine, iodine, cyano, C₁ to C₅ alkyl, alkoxy, acyl, alkylsulfonyl, aryl, carboxyl, or B(OH)₂, and at least one radical of R², R³, and R⁴ is not hydrogen,
wherein the curing agent has the general formula (III), wherein formula (III) is: 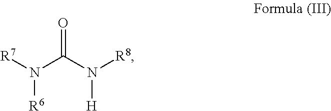
wherein R⁶, R⁷, and R⁸ are independent of one another, wherein R⁶ and R⁷ are independently hydrogen or C₁ to C₅ alkyl, wherein R⁸ represents:
C₁ to C₁₅ alkyl substituted with —NHC(O)NR⁶R⁷,
C₃ to C₁₅ cycloalkyl substituted with —NHC(O)NR⁶R⁷,
aryl substituted with —NHC(O)NR⁶R⁷, or
alkylaryl substituted with —NHC(O)NR⁶R⁷,
and wherein the epoxy resin composition does not comprise, in addition to the curing agent according to general formula (III), another curing agent selected from the group consisting of cyanamide, guanidines, cyanoguanidines, nitroguanidines, acylguanidines, biguanidines, and a compound according to general formula (IV), wherein formula (IV) is as follows: 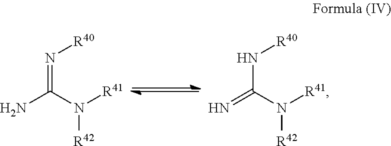
wherein radicals R⁴⁰, R⁴¹, and R⁴² are independent of one another, wherein:
R⁴⁰ represents a cyano, nitro, acyl or a radical of the formula —(C═X)—R⁴³, wherein:
X is imino or oxygen,
R⁴³ is amino, alkylamino or alkoxy,
R⁴¹ is hydrogen, C₁ to C₅ alkyl, aryl, benzyl, or acyl,
R⁴² is hydrogen or C₁ to C₅ alkyl.

2. The method according to claim 1, wherein radical R¹ in formula (I) represents a
methyl, ethyl, n-propyl, 1-methylethyl, n-butyl, 1-methylpropyl, 2-methylpropyl, n-pentyl, n-hexyl, n-heptyl, n-octyl, n-nonyl, n-decanyl, hydroxymethyl, 2-hydroxyethyl, 3-hydroxypropyl, 4-hydroxybutyl, or 5-hydroxypentyl.

3. The method according to claim 1, wherein R¹ in formula (I) is a radical of the formula (II), wherein:
R² is fluorine, chlorine, bromine, iodine, cyano, C₁- to C₅-alkyl, alkoxy, acyl, alkylsulfonyl, aryl, carboxyl or B(OH)₂, and
R³ and R⁴ are hydrogen.

4. The method according to claim 1, wherein R¹ in formula (I) is a radical of the formula (II), wherein radicals R², R³, and R⁴ are independent of each other, wherein:
R² and R³ are independently one of fluorine, chlorine, bromine, iodine, cyano, C₁ to C₅ alkyl, alkoxy, acyl, alkylsulfonyl, aryl, carboxyl or B(OH)₂, and
R⁴ is hydrogen.

5. The method according to claim 1, wherein R¹ in formula (I) is a radical of the formula (II), wherein radicals R², R³, and R⁴ are independent of each other, wherein:
R², R³, and R⁴ are fluorine, chlorine, bromine, iodine, cyano, C₁- to C₅-alkyl, alkoxy, acyl, alkylsulfonyl, aryl, carboxyl or B(OH)₂.

6. An epoxy resin composition comprising at least one epoxy resin and a curing agent for curing the epoxy resin, wherein the composition comprises at least one boronic acid of the general formula (I), wherein formula (I) represents: 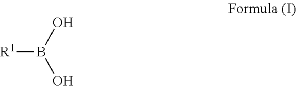
wherein radical R¹ represents an
alkyl, hydroxyalkyl or a radical of formula (II), wherein formula (II) is: 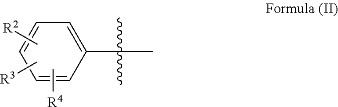
wherein R², R³, and R⁴ are independently one of hydrogen, fluorine, chlorine, bromine, iodine, cyano, C₁ to C₅ alkyl, alkoxy, acyl, alkylsulfonyl, aryl, carboxyl, or B(OH)₂, and at least one radical of R², R³, and R⁴ is not hydrogen, wherein the curing agent has the general formula (III), wherein formula (III) is: 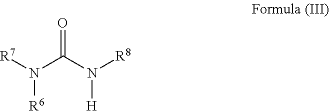
wherein R⁶, R⁷, and R⁸ are independent of one another, wherein R⁶ and R⁷ are independently hydrogen or C₁ to C₅ alkyl, wherein R⁸ represents:
C₁ to C₁₅ alkyl substituted with —NHC(O)NR⁶R⁷,
C₃ to C₁₅ cycloalkyl substituted with —NHC(O)NR⁶R⁷,
aryl substituted with —NHC(O)NR⁶R⁷, or
alkylaryl substituted with —NHC(O)NR⁶R⁷,
and wherein the epoxy resin composition does not comprise, in addition to the curing agent according to general formula (III), another curing agent selected from the group consisting of cyanamide, guanidines, cyanoguanidines, nitroguanidines, acylguanidines, biguanidines, and a compound according to general formula (IV), wherein formula (IV) is as follows: 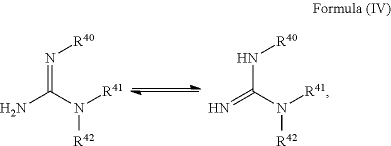
wherein radicals R⁴⁰, R⁴¹, and R⁴² are independent of one another, wherein:
R⁴⁰ represents a cyano, nitro, acyl or a radical of the formula —(C═X)—R⁴³, wherein:
X is imino or oxygen,
R⁴³ is amino, alkylamino or alkoxy,
R⁴¹ is hydrogen, C₁ to C₅ alkyl, aryl, benzyl, or acyl,
R⁴² is hydrogen or C₁ to C₅ alkyl.

7. Epoxy resin composition according to claim 6, wherein the epoxy resin composition based on 100 parts by weight of epoxy resin comprises:
a) 1 to 15 parts by weight of curing agent according to formula (III), and
b) 0.05 to 3.0 parts by weight of boronic acid according to formula (I).

8. Epoxy resin composition according to claim 6, wherein the weight ratio of curing agent to boronic acid corresponds to a ratio in the range 1:1 to 300:1.

9. A fiber composite comprising the epoxy resin composition according to claim 6, wherein the fiber composite comprises a prepreg or a towpreg.

10. An article of manufacture comprising the epoxy resin composition according to claim 6, wherein the article of manufacture comprises a 1-component adhesive or an acoustic insulating material.
